(19) United States
(12) Patent Application Publication
(10) Pub. No.: US 2010/0277862 A1
(43) Pub. Date: Nov. 4, 2010

(54) DOCKING APPARATUS FOR PORTABLE MEDIA PLAYER

(75) Inventor: Hyun KIM, Hwaseong-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/767,498

(22) Filed: Apr. 26, 2010

(30) Foreign Application Priority Data
Apr. 30, 2009 (KR) 10-2009-0038274

(51) Int. Cl. G06F 1/16

(52) U.S. Cl. 361/679.41

(57) ABSTRACT

A docking apparatus for a portable media player may include a tray provided on a front of a center fascia in such a way as to be ejected forwards therefrom, wherein a lower portion of the portable media player is inserted into the tray and the tray supports the portable media player therein, an elastic unit provided on at least one place in the tray, and elastically supporting a lateral surface of the media player coupled to the tray, and a connecting terminal provided in the tray to be electrically connected to an external output terminal of the media player inserted into the tray, and electrically connected to a car audio system.

### CROSS-REFERENCE TO RELATED APPLICATIONS

The present application claims priority to Korean Patent Application Number 10-2009-0038274 filed on Apr. 30, 2009, the entire contents of which application is incorporated herein for all purpose by this reference.

### BACKGROUND OF THE INVENTION

1. Field of the Invention

The present invention relates to a docking apparatus for a portable media player, which is constructed to directly dock a portable media player such as an iPOD without using an additional exclusive cable, thus playing media data on a car audio system.

2. Description of Related Art

Generally, a car audio system is used to listen to music or the radio in a vehicle. The car audio system is a built-in playing system, typically including a CD player, a cassette player and a radio.

However, as the number of vehicle users has recently increased, the car audio system is limited in function, so that there are many cases in which a variety of portable media players (hereinafter, referred to as a media player) are connected to the car audio system.

As examples of media players which may be connected to the car audio system, there are an MP3 player, a CD player, a PDA, an external memory device, a notebook computer, an iPOD, etc. Among them, the usage scale of iPODs is very large so that the number of cumulative sales passes one hundred million.

Conventionally, in order to connect a media player such as an iPOD to the car audio system, there are a variety of methods; for example, a method of using a car pack, a method of using an FM transmitter, and a method of using an AUX terminal have been used.

Among the conventional methods, the method of using the AUX terminal which is provided on the car audio system and connected to external equipment is problematic in that an additional exclusive cable for connecting the AUX terminal to the media player is required.

Further, the AUX terminal is typically provided on a console or a center fascia. In the case where the AUX terminal is provided on the console, it is not easy to install the exclusive cable, and a user may exit a vehicle with the media player being left on the console, which is undesirable.

Further, in the case where the AUX terminal is provided on the center fascia, there is no proper space for receiving the media player connected by the exclusive cable, so that the media player may fall and break during driving.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to propose a docking apparatus for a portable media player, which enables a driver's media player to be conveniently played by a car audio system in a vehicle without using an additional exclusive cable, and allows the media player to be held in a location having good visibility, thus preventing the driver from leaving behind the media player when he or she exits a vehicle, and firmly supports the media player even if vibration occurs during driving.

In order to achieve the above object, according to one aspect of the present invention, there is provided a docking apparatus for a portable media player including a tray provided on a front of a center fascia in such a way as to be ejected forwards therefrom, wherein a lower portion of the portable media player is inserted into the tray and the tray supports the portable media player therein, an elastic unit provided on at least one place in the tray, and elastically supporting a lateral surface of the media player coupled to the tray, and a connecting terminal provided in the tray to be electrically connected to an external output terminal of the media player inserted into the tray, and electrically connected to a car audio system.

The elastic unit may include an elastic member coupled to an inner surface of the tray to elastically support the portable media player in the tray.

The elastic unit may include a touch panel disposed in the tray and selectively contacting with the portable media player, and an elastic member provided between the touch panel and the tray to elastically support the touch panel.

The elastic member may couple a middle portion of the touch panel to the tray and thus the touch panel is pivotally movable about the elastic member to increase a contact surface of the touch panel with the media player while the media player and the touch panel are engaged each other.

The touch panel may include at least a leg protruding towards an inner surface of the tray, wherein the leg includes an upper leg and a lower leg protruding in a predetermined length towards the inner surface of the tray from upper and lower portion of the touch panel, and wherein the upper and lower legs are disposed substantially in a perpendicular direction to an insertion direction of the media player.

At least one pair of elastic units may be provided in the tray in such a way as to face each other.

Portions of the tray other than an upper portion thereof may be closed, and the upper portion of the tray is open to receive the lower portion of the portable media player.

The tray may repeat an open state in which the tray is slidably ejected forwards from the center fascia and a locking state in which the tray is retracted into the center fascia and locked, whenever the tray is pushed.

In another aspect of the present invention, the elastic unit may include an elastic piece formed by cutting part of a wall of the tray to form a slot, wherein a lower portion of the elastic piece is integrally coupled to the tray such that the elastic piece is elastically moved about the lower portion thereof, and a hook protruding from an upper end of the elastic piece towards an inner portion of the tray in a predetermined length, thus selectively supporting the portable media player, wherein the hook is triangular-shaped to be gradually narrowed towards the inner portion of the tray from the elastic piece thereof, and wherein at least one pair of elastic units is provided on opposite sides of the tray in such a way as to face each other.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating a center fascia of a vehicle on which an exemplary docking apparatus for a portable media player according to the present invention is provided.

FIG. 2 is a view illustrating the state in which the media player is docked to the exemplary docking apparatus for the portable media player according to the present invention.

FIG. 3 is a side sectional view illustrating an exemplary docking apparatus according to the present invention.

FIG. 4 is a view illustrating the interior of the exemplary docking apparatus for the portable media player according to the present invention.

FIG. 5 is a perspective view illustrating an exemplary docking apparatus according to the present invention.

FIG. 6 is a plan view illustrating the exemplary docking apparatus according to the present invention.

FIG. 7 is a side view illustrating the exemplary docking apparatus according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the exemplary embodiments of the present invention will be described in detail with reference to the accompanying drawings.

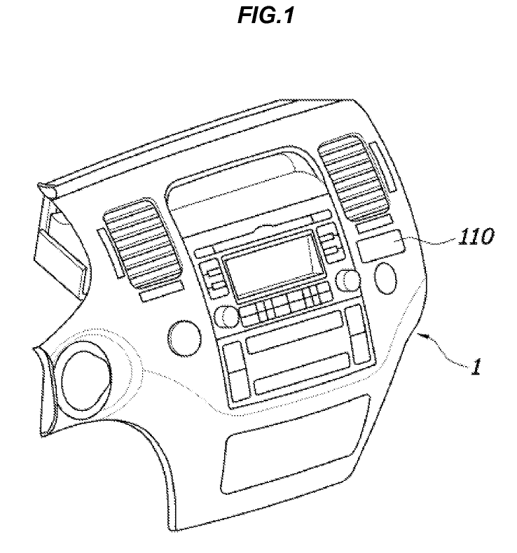

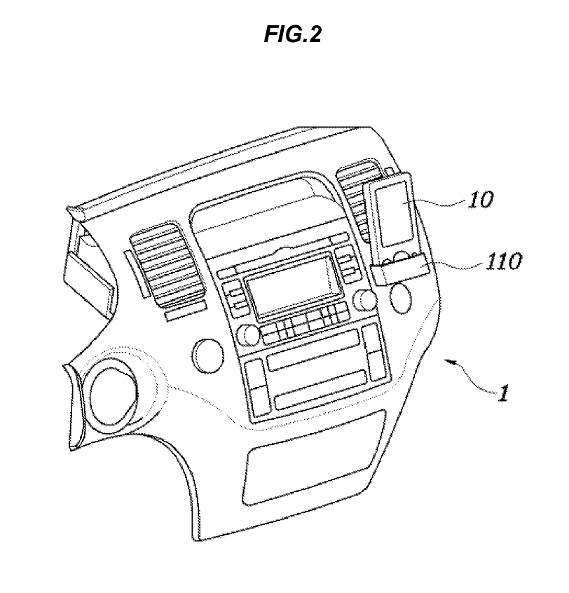

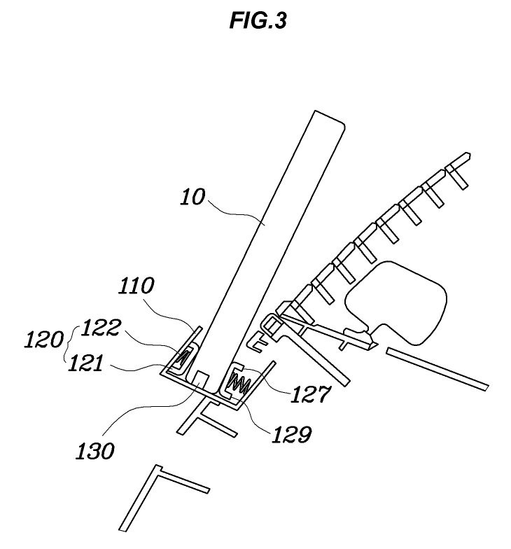

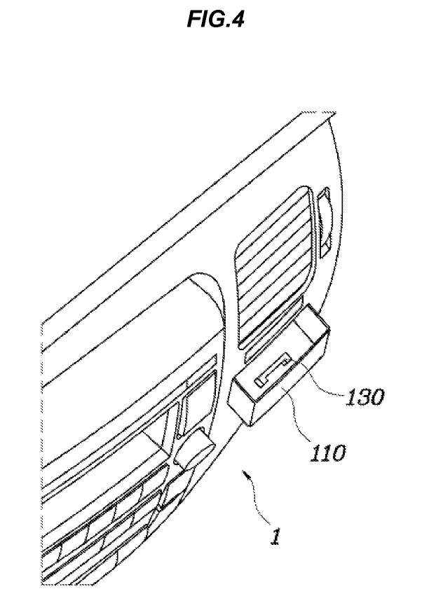

FIG. 1 is a view illustrating a center fascia of a vehicle on which a docking apparatus for a portable media player according to the present invention is provided, FIG. 2 is a view illustrating the state in which the media player is docked to the docking apparatus for the portable media player according to the present invention, FIG. 3 is a side sectional view illustrating a docking apparatus according to a first embodiment of the present invention, and FIG. 4 is a view illustrating the interior of the docking apparatus for the portable media player according to the present invention.

As shown in FIGS. 1 to 4, the present invention pertains to an apparatus which easily docks (connects) a portable media player to a car audio system provided in a vehicle without using an exclusive cable, thus allowing a driver to listen to audio signals stored in the media player through the car audio system. The apparatus includes a tray 110, an elastic unit 120 and a connecting terminal 130.

The media player 10 is substantially held on the tray 110. When the media player 10 is held on the tray 10, the media player 10 is automatically docked to the car audio system (not shown). It is preferable that the tray 110 be located at a position which is easily seen by a user. Thus, the tray 110 is mounted to the center fascia 1 in such a way as to be ejected forwards.

As shown in FIG. 2, in the state where the tray 110 is ejected from the center fascia 1, the media player 10 may be inserted into the tray 110. Here, the tray 110 is formed to a height which surrounds only the lower end of the media player 10 so that the media player 10 is supported even if only the lower end of the media player 10 is inserted into the tray 110.

In order for the tray 110 to surround only the lower end of the media player 10, as shown in FIGS. 2 and 3, all portions of the tray 110 except for an upper portion are closed, and only the upper portion is open.

The tray 110 slides in such a way as to be ejected forwards from the center fascia 1. The sliding action allows the tray 110 to be ejected when a user pulls the tray 110 out by his or her hand, and prevents the tray 110 from being ejected from the center fascia 1 so that the tray 110 is on the same level with the front of the center fascia 1 by pushing the tray 110 again when it is not in use.

However, more preferably, the tray 110 repeats an open state in which the tray 110 slides to be ejected forwards from the center fascia 1 and a locking state in which the tray 110 is retracted into the center fascia 1 and locked, whenever a user pushes the tray 110.

That is, when a user pushes the tray 110 which is retracted into the center fascia 1 and is on the same level with the front of the center fascia 1, with his or her hand, the tray 110 is automatically ejected forwards from the center fascia 1. When the tray 110 is pushed again, the tray 110 is retracted into the center fascia 1 again and is locked to an initial state shown in FIG. 1.

Since the sliding structure of the tray 110 operated as described above is usually and widely used, a detailed description will be omitted herein.

Meanwhile, the elastic unit 120 is installed on at least one place in the tray 110 to support the surface of the media player 10 inserted into the fray 110, thus preventing the media player 10 inserted into the tray 110 from unexpectedly shifting and allowing the media player 10 to be firmly secured to the tray 110.

According to the first exemplary embodiment of the present invention, as shown in FIG. 3, the elastic unit 120 may include a touch panel 121 which is in direct contact with the media player 10, and an elastic member 122 which is installed between the touch panel 121 and the tray 110.

The touch panel 121 is preferably made of a soft material to prevent the media player 10 from being damaged when the touch panel 121 is in contact with the media player 10. According to the present invention, the elastic member 122 includes a coil spring. However, without being limited to the coil spring, a member which has elastic force and may push the touch panel 121 towards the media player 10, for example, sponge may be used as the elastic member 122.

Furthermore, the elastic member 122 may couple a middle portion of the touch panel 121 and the tray 110. In this configuration, the touch panel 121 may be freely pivotable with the elastic member 122 such that contact surface between the media player 10 and the touch panel 121 is increased to firmly support the media player 10 while the media player 10 and the touch panel 121 are engaged each other.

In another exemplary embodiment of the present invention, the touch panel 121 may include upper leg 127 and lower leg 129 formed to be substantially in a perpendicular direction of the insertion direction of the media player 10. In this structure, the upper leg 127 and lower leg 129 may prevent the touch panel 121 from pivoting beyond a predetermined range by engaging with a bottom surface or lower inner surface of the tray 110 such that the media player 10 may be firmly supported by the tray 110.

Of course, it is not necessary that the elastic unit 120 include the touch panel 121 and the elastic member 122. The elastic unit 120 may include only a member retaining elastic force, such as a rubber pad or sponge.

Here, as long as the elastic unit 120 provides elastic force to the media player 10, the media player 10 is not moved but is supported. Thus, the elastic unit 120 may be provided on only one place in the tray 110.

However, as shown in FIG. 3, at least one pair of elastic units 120 may be installed in the tray 110 in such a way as to be opposite to each other, so that the easy insertion and removal of the media player 10 are ensured and the media player 10 is firmly supported while not being in direct contact with the tray 110.

In an exemplary embodiment of the present invention, two pairs of elastic units 120 may be provided in the tray 110 in front and rear direction of the vehicle in such a way as to face each other, because the elastic units 120 may absorb all vibration acting on the media player 10 backwards, forwards, rightwards and leftwards.

Further, as shown in FIG. 4, the connecting terminal 130 is provided in the tray 110 and is connected to an external output terminal provided on the media player 10 when the media player 10 is inserted into the tray 110. The connecting terminal 130 is electrically connected to the car audio system which is provided in the vehicle.

Thus, if the media player 10 is inserted into the tray 110, the external output terminal of the media player 10 is electrically connected to the car audio system, thus allowing a user to listen to the audio signal of the media player 10 through the car audio system without using an additional exclusive cable.

In FIG. 3, the connecting terminal 130 is formed only on the bottom of the tray 110, but is not connected to the car audio system. Since the technology of electrically connecting the connecting terminal 130 to the car audio system is not especially difficult, those skilled in the art may easily carry out the technology.

Further, the external output terminal of the media player 10 is generally formed on the lower portion of the media player 10 but may be formed at other positions. Thus, the connecting terminal 130 is preferably provided at a position corresponding to the external output terminal of the media player 10, and is not limited to a position which is shown in the drawings.

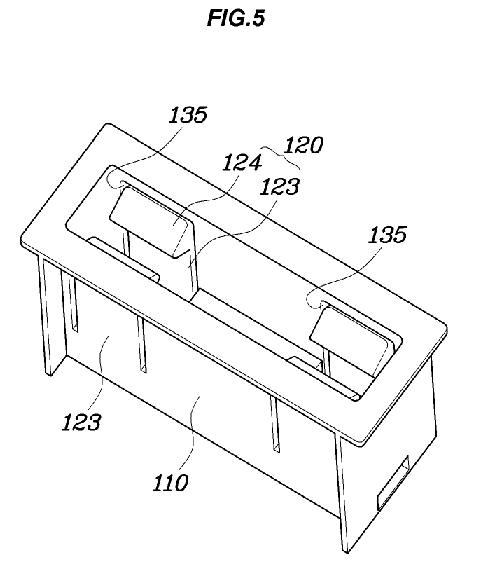

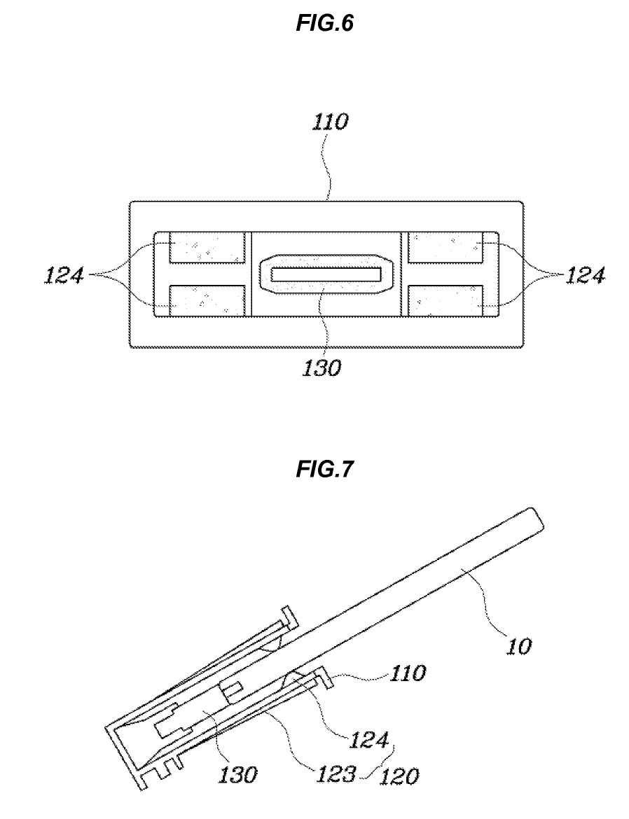

Meanwhile, FIGS. 5 to 7 are views illustrating a docking apparatus according to a second exemplary embodiment of the present invention, in which an elastic unit 120 of the second exemplary embodiment is different from that of the first exemplary embodiment. FIG. 5 is a perspective view illustrating the docking apparatus according to the second exemplary embodiment of the present invention, FIG. 6 is a plan view illustrating the docking apparatus according to the second exemplary embodiment of the present invention, and FIG. 7 is a side view illustrating the docking apparatus according to the second exemplary embodiment of the present invention.

Referring to FIGS. 5 to 7, the tray 110 and the connecting terminal 130 are equal to those of the first exemplary embodiment but the elastic unit 120 of the second exemplary embodiment is different from that of the first exemplary embodiment. Thus, only the elastic unit 120 will be described below.

The elastic unit 120 includes an elastic piece 123 and a hook 124. The elastic piece 123 is formed by cutting part of a wall (vertical surface) of the tray 110 to make a slot 135 around the elastic piece 123 in such a way as to be elastically moved on the tray 110.

The elastic piece 123 has a rectangular shape. Three of the four edges of the elastic piece 123 are cut and free to move with respect to the tray 110, while a remaining one is not cut and is integrally coupled to the tray 110.

Further, the hook 124 protrudes from an end of the elastic piece 123 to the inner portion of the tray 110, thus supporting the media player 10 inserted into the tray 110 as shown in FIG. 7. Such a construction allows the media player 10 to be easily inserted into the tray 110. The hook 124 is shaped to be gradually widened in a direction from an upper end thereof to a lower end thereof, thus making the elastic piece 123 move outwards relative to the tray 110 when the media player 10 is inserted into the tray 110.

Preferably, at least one pair of elastic units 120 is provided on opposite sides of the tray 110 in such a way as to face each other.

More preferably, two pairs of elastic units 120 may be provided in the tray 110 in front and rear of the vehicle in such a way as to face each other, because the elastic units 120 may absorb all vibration acting on the media player 10 backwards, forwards, rightwards and leftwards.

As described above, the present invention, in an aspect, provides a docking apparatus for a portable media player, which enables the portable media player such as an iPOD to be easily played through a car audio system in a vehicle without using an additional exclusive cable, thus achieving reduction in manufacturing cost attributable to the omission of the exclusive cable.

Further, the present invention, in another aspect, provides a docking apparatus for a portable media player, in which the media player is held in a location having good visibility such as a center fascia, thus matching an interior design, and only the lower end of the media player is supported, so that the space for substantially holding the media player is not large, thus being advantageous in terms of the freedom of design, and preventing a driver from leaving behind the media player when he or she exits a vehicle.

Furthermore, the present invention, in further another aspect, provides a docking apparatus for a portable media player, which effectively absorbs vibration transmitted from a vehicle even if only the lower end of the media player is supported, thus preventing the media player from shaking or preventing noise from being generated.

For convenience in explanation and accurate definition in the appended claims, the terms “upper”, “lower” “front” and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A docking apparatus for a portable media player, comprising:
a tray provided on a front of a center fascia in such a way as to be ejected forwards therefrom, wherein a lower portion of the portable media player is inserted into the tray and the tray supports the portable media player therein;
an elastic unit provided on at least one place in the tray, and elastically supporting a lateral surface of the media player coupled to the tray; and
a connecting terminal provided in the tray to be electrically connected to an external output terminal of the media player inserted into the tray, and electrically connected to a car audio system.

2. The docking apparatus as set forth in claim 1, wherein the elastic unit comprises an elastic member coupled to an inner surface of the tray to elastically support the portable media player in the tray.

3. The docking apparatus as set forth in claim 1, wherein the elastic unit comprises:
a touch panel disposed in the tray and selectively contacting with the portable media player; and
an elastic member provided between the touch panel and the tray to elastically support the touch panel.

4. The docking apparatus as set forth in claim 3, wherein the elastic member couples a middle portion of the touch panel to the tray and thus the touch panel is pivotally movable about the elastic member to increase a contact surface of the touch panel with the media player while the media player and the touch panel are engaged each other.

5. The docking apparatus as set forth in claim 4, wherein the touch panel includes at least a leg protruding towards an inner surface of the tray.

6. The docking apparatus as set forth in claim 5, wherein the leg includes an upper leg and a lower leg protruding in a predetermined length towards the inner surface of the tray from upper and lower portion of the touch panel.

7. The docking apparatus as set forth in claim 6, wherein the upper and lower legs are disposed substantially in a perpendicular direction to an insertion direction of the media player.

8. The docking apparatus as set forth in claim 3, wherein at least one pair of elastic units is provided in the tray in such a way as to face each other.

9. The docking apparatus as set forth in claim 3, wherein portions of the tray other than an upper portion thereof are closed, and the upper portion of the tray is open to receive the lower portion of the portable media player.

10. The docking apparatus as set forth in claim 4, wherein the tray repeats an open state in which the tray is slidably ejected forwards from the center fascia and a locking state in which the tray is retracted into the center fascia and locked, whenever the tray is pushed.

11. The docking apparatus as set forth in claim 1, wherein the elastic unit comprises:
an elastic piece formed by cutting part of a wall of the tray to form a slot, wherein a lower portion of the elastic piece is integrally coupled to the tray such that the elastic piece is elastically moved about the lower portion thereof; and
a hook protruding from an upper end of the elastic piece towards an inner portion of the tray in a predetermined length, thus selectively supporting the portable media player.

12. The docking apparatus as set forth in claim 11, wherein the hook is triangular-shaped to be gradually narrowed towards the inner portion of the tray from the elastic piece thereof.

13. The docking apparatus as set forth in claim 11, wherein at least one pair of elastic units is provided on opposite sides of the tray in such a way as to face each other.
